(19) United States
(12) Patent Application Publication
(10) Pub. No.: US 2008/0002258 A1
(43) Pub. Date: Jan. 3, 2008

(54) Reflecting Safety Element

(76) Inventor: Max Gregor Paping, St. Michielsgestel (NL)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 11/578,803

(22) PCT Filed: Apr. 19, 2005
(86) PCT No.: PCT/NL05/00287

§ 371 Date: Jun. 20, 2007

(30) Foreign Application Priority Data
Apr. 19, 2004 (NL) 1025972
Aug. 10, 2004 (NL) 1026815

(51) Int. Cl. G08B 5/00

(52) U.S. Cl. 359/516; 242/374

(57) ABSTRACT

The invention relates to a reflective safety element, comprising a reflective belt, a housing and a reel which is received in the housing and which is adapted to carry the belt in wound form, wherein the length of the belt is dimensioned for wearing on the body, and wherein the housing and the distal end of the belt are each provided with a mutually connectable coupling element. It hereby becomes possible to accommodate the safety element in a housing with an exterior such that it can be readily placed in a glove compartment, a map compartment or the like within easy reach of a driver of a passenger car or a truck.

The present invention relates to a reflective safety element, comprising a reflecting belt, a housing and a reel which is received in the housing and which is adapted to carry the belt in wound form.

Such a safety element is known from U.S. Pat. No. 4,858,551.

The safety element described in this document is intended for attaching a reflective strip to a vehicle. The use is particularly related to cases of vehicle breakdown, wherein a driver can mark his/her vehicle to make it more readily visible to drivers of approaching vehicles.

Experience has shown that in many cases drivers of disabled cars or of cars involved in an accident are the victim of collisions. Such collisions are usually caused because drivers of approaching vehicles do not notice the driver of the stationary vehicle present outside the vehicle.

The object of the present invention is to provide a safety element of the above stated type which avoids the above mentioned hazards.

This object is achieved in that the length of the belt is dimensioned for wearing on the body, and in that the housing and the distal end of the belt are each provided with a mutually connectable coupling element.

These measures make it possible to wear such a safety element on the body, for instance crosswise from one shoulder to the waist. It is noted here that there are of course other reflective elements that can be worn by people, such as the generally known safety jacket worn for instance by motoring organization patrols in similar situations. The average motorist does not however have such a safety jacket in his\her car. There is therefore a need for a safety element which can be worn easily round the body while still being stowable in a small volume, so that it can be easily picked up from the driver's seat and arranged on the body immediately before stepping out of the vehicle or immediately thereafter.

It is noted here that reflective belts are also per se known which can be worn on the body, such as are known from NL-A-8301902.

These belts have the drawback however that they cannot be wound up, so that in the use in question they lie crumpled up and become soiled in the boot of a car. They do not therefore wholly fulfil their reflective function, and the driver first has to walk to the boot without the protection of the reflective safety element.

These drawbacks are avoided by making it possible to wind up the reflective safety element. It herein becomes possible to accommodate the safety element in a housing with an exterior such that it can be readily placed in a glove compartment, a map compartment or the like within easy reach of a driver of a passenger car or a truck.

According to a first preferred embodiment, the reel is coupled to a spring mechanism which is adapted to wind up the belt.

This measure makes it easy to stow away the reflective safety element, after it has been used, for a subsequent use.

A spool mechanism is also known from U.S. Pat. No. 4,858,551, but this is provided with a hand-operated winding element without a spring.

As a result, this safety element is considerably less practical.

Another preferred embodiment provides the measure that the spring mechanism is dimensioned for generating in the belt a tensile force which holds the belt taut round the body. With this measure it is possible to arrange the belt on the body without the belt hanging loosely and for instance representing a hazard in the case work is carried out in the engine compartment with rotating parts.

This measure moreover makes it possible to modify the length to the body size of the user.

Yet another preferred embodiment provides the measure that the spring mechanism is placed on a shaft extending parallel to the reel shaft, wherein the spring mechanism is coupled to the reel by means of a band.

This measure makes it possible to make use of a small spring mechanism which does not necessarily have to be arranged concentrically relative to the reel shaft. Arranging of the elements hereby becomes easier, so that the elements can be accommodated in a smaller housing, and the user-friendliness is increased by the housing. These advantages are enhanced still further when the housing is substantially a prismatic oval, and the reel shaft extends parallel to the short axis of the oval.

A further improvement in the user-friendliness is achieved when the coupling element arranged on the distal end of the belt is received in the contour of the housing in the situation where the belt is wound onto the reel. This results in a great improvement of the appearance of the whole device, so that the motorist will more readily accept such a safety element in the vicinity of his/her driver's seat.

For the same reason the housing preferably has a maximum dimension of between ten and fifteen centimeters.

If in the Netherlands and in a number of other European countries a motorist is confronted with breakdown, he/she is obliged to place a warning triangle 30 metres behind the car. This of course draws attention to the presence of the vehicle, but the warning triangle does not itself give any indication of where the car is located. In order to avoid this drawback, the present invention therefore provides the measure in a preferred embodiment that the housing is provided with fixing means for fixing a number of safety means to the housing.

These safety means can then be used to mark the position of the vehicle. These safety means are preferably formed for this purpose by reflective strips.

In order to arrange these safety means in the form of reflective strips easily on the metal housing of a vehicle, they are preferably magnetic.

The present invention will be elucidated hereinbelow with reference to the accompanying drawings, in which:

FIG. 1 shows a perspective view of a safety element according to the invention;

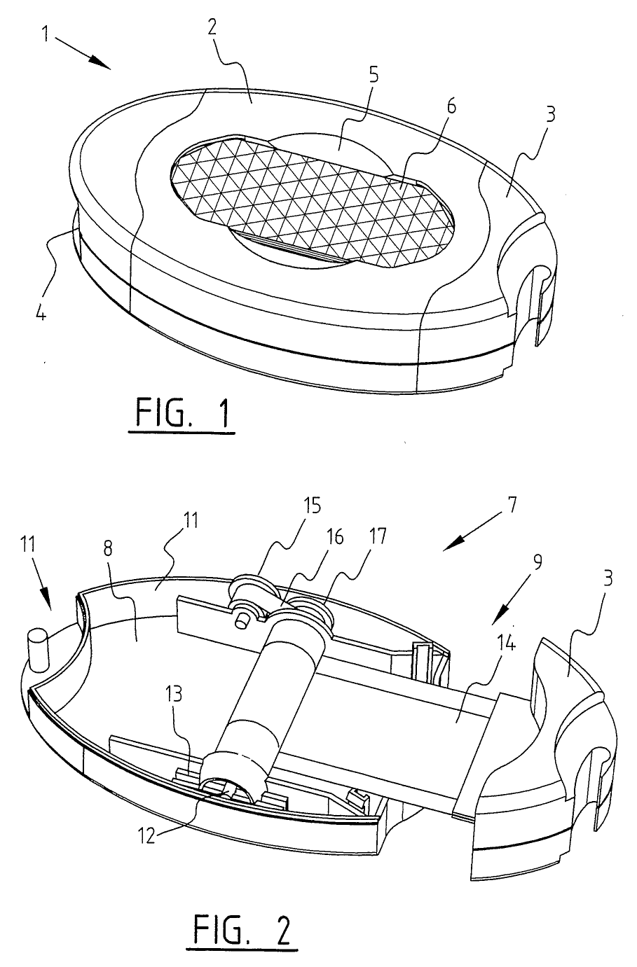

FIG. 2 shows a perspective view of one half of a housing of a device according to the present invention with the components arranged therein;

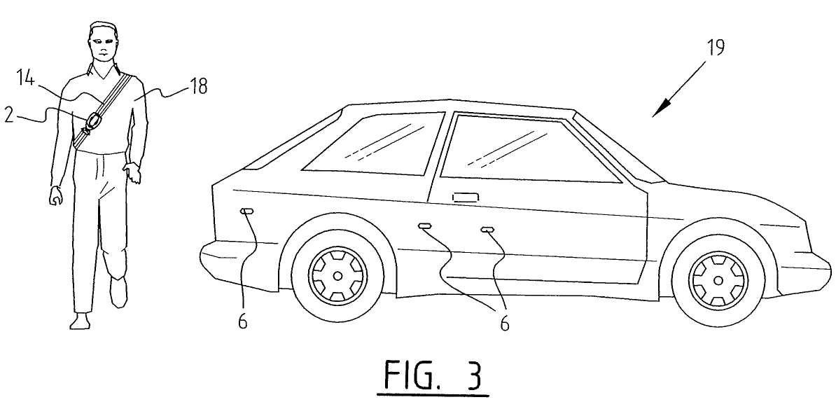

FIG. 3 shows a user wearing the safety element according to the present invention on his body, and a car provided with magnetic reflective strips.

FIG. 1 shows a safety element according to the invention. Safety element 1 comprises a housing 2 provided with a connecting element 3. This connecting element 3 can be coupled to coupling means (not shown) arranged in recess 4. The housing is further provided with a recess 5 in which magnetic reflective strips 6 are arranged.

FIG. 2 shows a housing half 7 which is manufactured for instance from plastic and which is intended for assembly with an associated housing half which is embodied in mirror image at least on the outside and which is not shown in the drawing. Housing half 7 has a substantially flat bottom wall 8 which has the form of an ellipse, wherein a recess 9 is arranged on one side of a long axis. Bottom wall 8 is provided on its edges with half-height side walls 10 extending substantially all-around. On the side opposite recess 9 the side wall 10 is placed inward. A space 11 is hereby formed in which a coupling can be made to the distal end of a belt to be further elucidated.

Parallel to and at the position of the short axis of the ellipse of the bottom wall there is arranged a mechanical shaft 12 which forms the reel shaft. Reel shaft 12 is mounted on plastic parts 13 arranged for this purpose in housing half 7. A belt 14 of reflective material is attached to reel shaft 12.

Belt 14 is preferably manufactured from plastic and provided on one side with a layer of reflective material. It is also possible to provide belt 14 with a layer of reflective material on both sides. The reflective material can extend over the whole surface on one side of the belt, but can also extend over a part thereof, for instance only the part in the middle of the belt.

As already stated, belt 14 is connected at one end to reel shaft 12, so that by turning reel shaft 12 the belt 14 can be wound thereon. At its distal end the belt 14 is connected to a connecting element 3, one half 3 of which is shown in FIG. 2. This is a plastic component 3 which is assembled with a relevantly formed other half by means of gluing or by means of clamping, and which thereby forms a connection to the distal end of belt 14.

The design of connecting element 3 is herein such that it fits inside the contour of housing half 7 in the wound-up situation of belt 14.

In order to wind up belt 14 use is preferably made of a spring mechanism 15 which is likewise accommodated in housing 2.

Spring mechanism 15 is connected by means of a band 16 to a secondary reel 17 which is also arranged on reel shaft 12. Spring mechanism 15 is constructed such that it is wound up when the belt is pulled out, in that the rotation of reel shaft 12 is transmitted by means of band 16 to spring mechanism 15. Spring mechanism 15 will therefore exert a force on band 16 which ensures that the belt is pulled as far inside as possible.

When the belt is arranged on the body, it is pulled out as far as possible by the user pulling on the two assembled connecting elements 3 and coupling these by means of a coupling to a coupling means (not shown) arranged in recess 4. A situation then results as shown in FIG. 3. A user 18, whose car has for instance just broken down, is here wearing round the body the belt 14 that has been pulled out of housing 2. FIG. 3 further shows a car 19 on which magnetic reflective strips 6 are arranged. Car 19 hereby becomes immediately noticeable when it is illuminated in the dark.

After use the spring mechanism will pull the belt back onto the reel inside the housing, so that the safety element can once again be stowed within easy reach of the motorist.

It is pointed out here that diverse variations can be made to the configuration shown here. It is thus of course possible to make use of other internal constructions of the reel and the like, while the exterior of the housing can also be changed, for instance to a substantially rectangular or other shape of housing.

It is thus possible to cover such a housing with soft material such as textile, so that it fits in with the designs applied in the case of sport. The device according to the present invention is then particularly suitable for wearing by for instance joggers or cyclists when they practise their sport.

1. Reflective safety element, comprising a reflective belt, a housing and a reel which is received in the housing and which is adapted to carry the belt in wound form, characterized in that the length of the belt is dimensioned for wearing on the body, and that the housing and the distal end of the belt are each provided with a mutually connectable coupling element.

2. Safety element as claimed in claim 1, characterized in that the reel is coupled to a spring mechanism which is adapted to wind up the belt.

3. Safety element as claimed in claim 2, characterized in that the spring mechanism is dimensioned for generating in the belt a tensile force which holds the belt taut round the body.

4. Safety element as claimed in claim 2 or 3, characterized in that the spring mechanism is placed on a shaft extending parallel to the reel shaft, and that the spring mechanism is coupled to the reel by means of a band.

5. Safety element as claimed in any of the foregoing claims, characterized in that the housing is substantially a prismatic oval, and that the reel shaft extends parallel to the short axis of the oval.

6. Safety element as claimed in claim 5, characterized in that the coupling element arranged on the distal end of the belt is received in the contour of the housing in the situation where the belt is wound onto the reel.

7. Safety element as claimed in claim 5 or 6, characterized in that the housing has a maximum dimension of between 10 cm and 15 cm.

8. Safety element as claimed in any of the foregoing claims, characterized in that the housing is provided with fixing means for fixing a number of safety means to the housing.

9. Safety element as claimed in claim 8, characterized in that the safety means are formed by reflective strips.

10. Safety element as claimed in claim 9, characterized in that the safety means are magnetic.

11. Safety element as claimed in any of the claims 1-7, characterized in that the housing is covered with a soft material such as textile.
